(19) United States
(12) Patent Application Publication
(10) Pub. No.: US 2026/0300148 A1
(43) Pub. Date: Oct. 1, 2026

(54) AUTOMATED BUG TRIAGE

(71) Applicant: Notion Labs, Inc., San Francisco, CA (US)

(72) Inventors: Karn Saheb, Emeryville, CA (US); Harsha Vardhan Mudumba Venkata, San Francisco, CA (US)

(21) Appl. No.: 19/242,817

(22) Filed: Jun. 18, 2025

Related U.S. Application Data
(60) Provisional application No. 63/779,678, filed on Mar. 28, 2025.

(51) Int. Cl. G06F 11/3698; G06F 11/362

(52) U.S. Cl. CPC G06F 11/3698; G06F 11/366

(57) ABSTRACT

This application relates to approaches for automatic bug triage. Bug reports and/or tasks can be analyzed using a machine learning model, such as a large language model (LLM), in order to identify a product area or domain associated with the bug. In some implementations, a multi-stage process is used. For example, in some implementations, vector embeddings are used to determine a set of possible product areas or domains, and a machine learning model (e.g., an LLM) is used to select a product area or domain from the set. The bug can be assigned to the selected product area or domain. In some implementations, a machine learning model is used to determine one or more bug priority factors that can be used to determine an overall priority for addressing a bug. In some implementations, the approaches herein can enable the automatic assignment of bugs to particular teams or developers.

### CROSS-REFERENCE TO RELATED APPLICATIONS

This application claims priority to and the benefit of U.S. Provisional Patent Application Ser. No. 63/779,678, filed Mar. 28, 2025, which is incorporated by reference herein in its entirety.

### BACKGROUND

Bugs in computer software are flaws or errors in a program's code that cause it to behave unexpectedly or produce incorrect results. These issues can arise from various sources, including logical errors, incorrect assumptions, unforeseen interactions between different parts of the software, or errors or assumptions in user interface layouts. Bugs can range from minor inconveniences, such as a misaligned user interface element, to critical vulnerabilities that compromise security, data integrity, application usability, and so forth. Identifying and fixing bugs is an important but complex part of software development.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is a flowchart that illustrates an example process for triaging a bug report according to some implementations.

FIG. 5 is a flowchart that illustrates an example multi-step machine learning process for bug triage according to some implementations.

FIG. 6 is a block diagram that illustrates an example of machine learning model training and deployment according to some implementations.

FIG. 7 is a table that shows an example of bug priorities determined based on priority factors of bug severity and user flow priority according to some implementations.

FIG. 8 is a flowchart that shows an example process for updating a bug severity according to some implementations.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for systems and methods for triaging bugs. Addressing bugs or inherent problems (generally “bugs”) in products such as computer software, computer hardware, complex manufactured items (e.g., automobiles), and so forth can be a challenging task. There are often many different teams that work on a product, bugs can have different priorities, different severities, and so forth. In some cases, it can be difficult to reproduce a bug, or a bug may not actually be reproducible. This can be especially challenging in the case of user-reported bugs, where a bug report may not include much information, or the information that is included may be inaccurate, incomplete, etc. Currently, triaging bugs is often a largely manual process that can take significant time. Moreover, triaging is often inconsistent, relying on individual judgment about the priority, severity, and so forth.

Time spent triaging bugs and errors or inconsistencies in triaging bugs can result in wasted time and fewer bugs being fixed. Errors or deficiencies in assigning bugs to teams, determining priorities, and so forth can delay fixes, waste time, result in bugs that are actually high priority waiting to be fixed while bugs that are actually lower priority are fixed first, and so forth.

Accordingly, there is a need for improved systems and methods to improve bug triaging. The systems and methods described herein can reduce the time needed to triage bugs, improve the accuracy of bug triage, improve the consistency of bug triage, and so forth. The need for review by humans with specific expertise can be reduced or even eliminated as the systems and methods herein can enable the automatic, accurate triage of bugs. In some implementations, the systems and methods herein automatically route bugs to appropriate teams after triage. In some implementations, the systems and methods herein automatically prioritize bugs. In some implementations, the systems and methods herein automatically reprioritize bugs based on one or more factors such as available resources, number of outstanding bugs, and so forth.

Bug reports can include a wide variety of information. Information in bug reports can include automatically gathered information (e.g., information gathered automatically when an application encounters an error or a user selects a bug reporting feature in the application), user-supplied information, or both. For example, a bug report can include the application name, application version, web browser name, web browser version, user agent string, operating system type, operating system name, operating system version, and so forth. Such information can be beneficial for identifying the specific affected version of the application, identifying which web browser an error occurs in (e.g., in the case of a web-based application), and so forth. Bug reports can include information such as a debug report, crash log, memory dump, error message, timestamp, region, language, display resolution, display scaling factor, and so forth. Information such as region or language can be beneficial because, for example, an error in a user interface may only be apparent when certain languages are used, or a bug in a feature may only appear in certain regions as features may be modified to conform to legal requirements in different jurisdictions. In some cases, a bug report may include one or more screenshots (which may be automatically captured and/or captured by a user), a user-provided description, a user-provided severity, and so forth. In some cases, users may provide an indication of what area of an application they are experiencing a problem with, a type of error (e.g., unexpected behavior, crash, slow performance), and/or other information that may be useful in addressing the error. In some cases, users may submit bug reports that are not actually reports for bugs but rather feature requests, requests for user interface changes, and so forth.

In some implementations, domain tags are used to classify bugs, for example into specific product areas. A “domain tags” can refer to custom labels or tags—implemented as select or multi-select properties in a database—that categorize content by broad areas such as departments, business functions, or knowledge domains (e.g., “Marketing,” “Legal,” “Engineering”). These tags help users organize, filter, and group information, making it easier to locate relevant content and collaborate across teams.

In some implementations, domain tags can be associated with specific developer teams. Multiple domain tags may be assigned to the same developer team. The systems and methods herein can utilize retrieval augmented generation for classification, although other techniques are also possible. For example, the systems and methods herein can query domain tags (e.g., all domain tags) defined in a database. Each domain tag can be associated with one or more product areas. Domain tags can include various information, such as a name, plain text description of the product area, priority associated with the product area, and so forth. Relevant details of the domain tags can be stringified and converted into vector embeddings, for example using a sentence transformer. In some implementations, the sentence transformer is trained or fine-tuned so that similar domain tags have vector embeddings that are more similar to each other than the vector embeddings for domain tags that are unrelated to one another. The vector embeddings can map semantic similarity to proximity in vector space (e.g., domain tags that are more similar can be closer in the vector space). In some implementations, the vector embeddings are stored in memory (e.g., in volatile memory, non-volatile memory, or both) and used for subsequent queries for semantic similarity.

The systems and method herein can process newly created bug reports (e.g., bug reports that have not yet been triaged). The bug reports can be stored as tasks in a database (e.g., a block database as described herein), such as a project management database, or can be used to generate tasks. In some implementations, bug reports directly give rise to tasks (e.g., a bug report can be treated as a task). In some implementations, bug reports are used to generate tasks. In some implementations, multiple bug reports may be used to create a single bug task if the bug reports are all related to the same bug). The tasks can be stringified using certain relevant information such as name, bug details, and any additional context. Each stringified task can be fed into an embedding model to determine the semantic similarity of each task to the vector embeddings of the domain tags. The systems and methods herein can select the top matches (e.g., the top k results) and associate the top domain tags with the task. The top k results can be based on semantic similarity. In some implementations, the top k results from the embeddings comparisons are used to retrieve the matching domain tags, which can be associated with the bug task.

Determining the top k domain tags can be done based on, for example, vector similarity. Various measures can be used, such as L1 distance, L2 distance, dot product, and/or cosine similarity. In some implementations, the number of top domain tags (k) is fixed (e.g., the top two, three, four, five, six, seven, eight, etc., domain tags). In some implementations, the number k is not fixed but can instead be based on, for example, the number of domain tags with a vector similarity above a threshold value. For example, in the case of cosine similarity, in which the similarity value is bound to be within the range [0, 1], the top domain tags can include those with a similarity above a threshold such as 0.5, 0.6, 0.7, 0.8, 0.9, or any other value between zero and one. In some implementations, the threshold can be adjusted over time. For example, a system can automatically adjust the threshold in an effort to better ensure that the identified domain tags include an appropriate domain tag while keeping the set of selected domain tags small enough that the correct domain tag can be identified in future processing operations. For example, if there are ten domain tags but the similarity step consistently picks only one domain tag, there will be no benefit to subsequent LLM processing as described herein for purposes of assigning a domain tag. Similarly, if the vector comparison always results in nine or ten of the domain tags being identified as possible matches, there may be little or no benefit to performing vector similarity comparisons, as opposed to simply providing all the possible domain tags to an LLM in other processing steps.

In some implementations, the systems and methods herein generate an input for a machine learning model using the task and corresponding embeddings or domain tags. In some implementations, the input is a prompt for a large language model (LLM). The prompt can include context (e.g., the role of the model), instructions for how to perform classification, and instructions for how to structure the results. For example, in some implementations, the prompt instructs the LLM to output results in JavaScript Object Notation (JSON) or another format to facilitate further processing. In some implementations, the prompt contains details describing the task, the subset of domain tags (e.g., the top k domain tags), constraints on the assignment (e.g., asking for only high confidence levels, to only use provided information, to only provide assignments if they can be reasonably ascertained, etc.), and so forth. In some implementations, the systems and methods herein utilize a reward mechanism and chain-of-thought prompts to produce a desired accuracy. In some implementations, the systems and methods herein provide examples to guide the LLM.

In some implementations, the LLM determines which of the provided domain tags (e.g., which of the top k domain tags) should be associated with a task. In some implementations, the LLM assigns a priority to the task, for example as described in more detail herein. In some implementations, the LLM assigns a severity to the task.

In some implementations, prompts are submitted in batches to an LLM, which can perform inference and return corresponding outputs in a desired format. The systems and methods herein can sanitize the outputs for further processing. For example, the systems and methods herein can parse the outputs into valid object types, identify and handle errors, and so forth.

It can be significant to add additional information to tasks. For example, the inference output can be decorated with additional metadata based on, for example, domain tags identified during inference. The metadata can include a mapping of the corresponding team(s), identification of customer support partners associated with the product area, and so forth. Such additional information (also referred to as decorations) can be significant as it can ensure that a bug task is routed to the correct team for fixing. Additionally or alternatively, identifying the correct customer support partners can be important, as they may use this information when working with customers, for example, to check that a bug has been reported and has been assigned to a team for fixing. The systems and methods herein can update an original task based on the outputs of the LLM. For example, the systems and methods can update the product area, priority, severity, and/or the like. In some implementations, the systems and methods herein utilize one or more application programming interfaces to retrieve information from a project management application and/or to update tasks in the project management application. In some implementations, the program management application comprises or is built from an integrated workspace in which data is stored in hierarchical blocks, for example as described herein.

Developers and engineers often devote significant time to addressing bugs. It may not be viable for a company to dedicate additional time to fixing bugs. Even if a great deal of resources is available to address bugs, developing fixes can take a significant amount of time and effort. Thus, it can be important to prioritize bugs to address the most critical first. Many organizations lack a consistent set of rules or principles for determining bug priorities, and even when such rules or principles do exist, different individuals may apply them differently.

In some implementations, the systems and methods herein determine bug priorities based on a plurality of priority factors. Priority factors can be indicative of, for example, the likelihood that a user will encounter a bug, the likelihood that a bug presents a security risk, the likelihood that a bug presents a data integrity risk, the likelihood that a but presents an application stability risk, and so forth. In some implementations, priority factors consider, additionally or alternatively, a type of customer who experiences the bug or reports the bug. For example, if a service offers a free tier and a paid enterprise tier, bugs may be treated as higher priority when they are submitted by paid enterprise tier customers. In some implementations, bug priorities are stored as a property of a bug task in a task database (e.g., as a property of a block, as described herein). In some implementations, priority factors are stored as properties of a task. This can be advantageous because it may be desirable in some circumstances to manually modify a value assigned to a priority factor. Priority factor values can be manually edited by users (e.g., users with appropriate permissions), for example to indicate that a bug is more or less severe than its current assigned priority would indicate. In some implementations, when a user updates a priority factor value, the system automatically updates the bug priority based on the updated priority factor value.

Described herein are approaches for prioritizing bugs in a way that ensures the most important features, product flows, usage methods, and so forth are prioritized over, for example, features or product flows that are used by relatively few users or bugs that do not prevent usage of a product feature or flow.

In some implementations, the approaches herein use a combination of factors in determining bug priority. For example, some implementations utilize user flow priority and bug severity. User flow priority can quantify or categorize a bug based on how important the user flow or feature impacted by the bug is to the product. In some implementations, bugs are assigned to one of a limited number of user flow priority categories. For example, priority one can be assigned to features that are the most widely used and important, priority two can be assigned to intermediate features, and priority three can be assigned to the least used or least important features. For example, in a mobile social media application, a bug that affects the ability of users to post photos may be priority zero, while a bug that sometimes prevents users from liking another user's post may be priority one, and a bug that prevents users from managing their block list via the application may be priority two. In some cases, priorities can be related to the importance of a feature (e.g., whether or not the feature represents core functionality of a product). User flow priorities can be based, additionally or alternatively, on other factors. For example, consider an application programming interface. Bugs in highly used API calls can be assigned a higher user flow priority than bugs in relatively infrequently used API calls. It will be appreciated that in the context of bug prioritization, user flow does not necessarily imply usage by a human user, but could include, additionally or alternatively, usage by other applications or services.

User flow priority can focus on the proportion of users affected by a bug, as opposed to the severity of the bug, which can be considered as a separate priority factor. This can be significant because, for example, even if a bug does not significantly impact functionality of an application, it can be important to address quickly if the bug is apparent to a large portion of users of the application. The proportion of users can be all users of an affected product or a subset of users of an affected product. For example, an integrated workspace platform may provide applications for a variety of devices, operating systems, etc. In determining a user flow priority for a bug, all users of the integrated workspace platform may be considered, or only users that use a particular application may be considered (e.g., all users who utilize an Android application for accessing the integrated workspace platform, all users who utilize a web interface for accessing the integrated workspace platform, etc.).

In some implementations, the user flow priority can be determined based on a ratio indicating the proportion of users that are exposed to a particular user flow. As an example, consider an application for a first operating system (e.g., iOS). The baseline users can be all iOS users of the application. If the bug affects the ability to upload images, the percentage of the baseline that is impacted can be (number of users who use the image upload feature)/(number of iOS application users). If the ratio is above a first threshold amount, the bug can be assigned a user flow priority of one. If the ratio is below the first threshold amount and above a second, smaller, threshold amount, the bug can be assigned a user flow priority of two. If the ratio is less than the second threshold amount, the bug can be assigned a user flow priority of three. These are merely examples, and the number of user flow priorities and particular thresholds for each can vary. For example, there can be four possible user flow priorities with three corresponding thresholds, five user flow priorities with four corresponding thresholds, etc. In general, there can be N user flow priorities with N−1 corresponding thresholds.

The particular thresholds, number of priorities, etc., can be the same for an entire product or can vary, for example by product team.

As described herein, bug severity can be another priority factor that is considered in bug prioritization. The bug severity factor can ask how bad a bug is. In some implementations, severity can be classified into one of a plurality of categories, such as High, Medium, and Low. In some implementations, there can be a highest category that includes only the most critical bugs that need to be addressed as quickly as possible (e.g., a “fix now” category).

As an example, consider a bug in a mobile application that causes opened web links to be unable to be navigated or closed. This can be considered a high severity bug as it completely stops users from using web links. As another example, consider a bug that is purely visual, such as there being too little padding in a user interface element. Such a bug can be considered low severity as it is purely visual and does not impact a user's ability to use a feature associated with the user interface element.

Various factors can be considered in determining bug severity. Factors can include, for example, reproducibility, volume of user reports, frequency of user reports, extent of degradation (e.g., does the bug completely prevent usage of a feature or is it a partial or non-blocking degradation), bug type (e.g., functionality, security, data loss, user interface), revenue impact, risk to business, risk to brand, and so forth. In some implementations, bugs that result in security issues or data loss can be considered more severe than, for example, bugs that impact only the user interface. This can be true even if the user interface bug prevents certain features from working as intended.

Table 1 shows an example of bug priorities based on two priority factors. In Table 1, two factors, bug severity and flow priority, are used to determine an overall bug priority for a bug.

TABLE 1

Bug Severity →

| ↓ Flow Priority | Fix Now | High | Medium | Low |
|---|---|---|---|---|
| 1 | Urgent | High | High | Medium |
| 2 | Urgent | High | Medium | Low |
| 3 | Urgent | Medium | Low | Low |
| N/A | Urgent | High | Medium | Low |

As indicated in Table 1, in some cases, a bug may not have an associated flow priority. For example, in the case that flow priorities are assigned manually, a developer, engineer, or the like may not have added a flow priority, or in the case that flow priorities are determined automatically, a system may not have determined a flow priority because, for example, there is insufficient data to accurately determine a flow priority (e.g., for a recently-introduced feature). If a bug cannot be mapped to a user flow, the priority assigned to the bug can be driven entirely by the bug severity (e.g., in the case that only two factors are used to determine priority) or by a combination of other factors (e.g., in the case that there are multiple other factors considered in determining bug priority).

In some implementations, bug priorities are initially set based on a single priority factor, and then adjusted based on one or more other priority factors. For example, in the case where a first priority factor is user flow priority and a second priority factor is bug severity, a bug can initially have its priority set based only on user flow priority. For example, flow priority one bugs can be automatically designated as high priority bugs, flow priority two bugs can be automatically designated as medium priority bugs, and flow priority three bugs can be automatically designated as low priority bugs. Rules can be applied to determine how the bug severity impacts the priority. For example, for high priority bugs (e.g., user flow priority one), if the bug severity is low, the priority can be downgraded from high priority to medium priority. For bugs with medium priority (e.g., user flow priority two), such bugs can be automatically upgraded to high priority if the bug severity is high or downgraded to low priority if the bug severity is low. For bugs with low priority (e.g., user flow priority three), the priority can be automatically upgraded from low to medium if the bug severity is high. The same approach can be readily adapted to a scenario in which bug severity is used as the starting point for priority assignments, and user flow priority is used to adjust such priority assignments. In some cases, it can be significant to place the major focus on user flow priorities, as such an approach can emphasize fixing bugs in a manner that enhances the product quality perceived by users.

The approaches described above can provide several advantages. For example, the approaches herein can provide a balanced focus on bug severity and user flow priority. That is, the approaches herein can ensure that both bug severity and user flow priority are considered. Thus, for example, for high priority flows, even low severity bugs can be treated with medium priority, for example because these flows are important and the bug affects the overall user experience significantly. As an example, a bug related to user interface polish (e.g., a misaligned button or cut off text) may not impact users' abilities to use an application, but may nonetheless be assigned a medium priority because such a bug may be highly visible to users and failing to fix it can give users the impression that the application is of poor quality or sloppily put together.

Returning to the previous examples, the web link bug can have both a high user flow priority and a high bug severity, because this is a commonly-used feature that has a high impact on usability of the feature. The user interface element padding bug has a low severity because it does not actually impact usability but can have a high user flow priority if the user interface element is commonly used by users of the application (e.g., incorrect padding in a search box).

The approaches herein can assign an appropriate priority to high severity bugs, even if such high severity bugs are related to features with low user flow priorities.

The approaches herein can focus on flow priority over user reports. User reports are generally a poor signal as the number of users who bother to report a bug is typically very small compared to the number of users actually experiencing the issue. This can also vary by feature. For example, if a bug only mildly inconveniences users, they may be significantly less likely to report it than they would be if the bug were impacting their ability to use the application. By focusing on user flow priority, the approaches herein can ensure that the most important flows are prioritized.

In some implementations, bug priorities can be set via rules or formulas, thereby eliminating or reducing the need for developers, quality assurance engineers, and so forth to manually set bug priorities or manually apply bug prioritization criteria. This can be significant as different developers, engineers, support agents, and so forth may apply subjective assessments, resulting in inconsistent prioritization of bugs and potentially causing some more pressing bugs to take lesser precedence than other bugs that are less impactful.

While a set of rules for determining priorities to be assigned to bugs is beneficial, it will be appreciated that applying the rules can present certain challenges. For example, different groups may use different criteria for determining relevant thresholds for assigning a bug to one user flow versus another or to one severity versus another. Assumptions about user flow usage may be inaccurate, and even if they are accurate initially, can become inaccurate over time as new features are introduced, old features are retired, user interfaces are reconfigured, and so forth, which can result in changes in how users utilize an application. Even if the application remains largely static in the features that are presented to users and the interface used to present those features, different features may be used differently over time. For example, if an application is initially used primarily by small teams or individuals but eventually becomes used by large entities such as large corporations, governments, and so forth, the relative usage of certain features can change. For example, individual users are likely to have less use for complex collaboration features or integrations with third party applications or platforms, but may spend more time utilizing personalization features, such as selecting cover images, changing background colors, altering fonts, and so forth. In a large corporation, however, users may make extensive use of collaboration features and other more complex features while having less use for personalization features. For example, consider a word processing application. Individual users may spend a significant amount of time customizing fonts, layouts, and so forth, while corporate users may simply use company-approved templates but may frequently collaborate with other users on documents.

Other factors can also change over time. For example, bug severity can change over time. As an example, at a first time, there may only be a single method for users to make use of a particular feature. If that method is broken, users cannot use the feature. Over time, an application may introduce additional ways to utilize the feature. Thus, at the later time, even if one method is broken, users can still make use of the feature. Such changes can also affect user flow priority. For example, users may begin to prefer a newer way of accessing or utilizing a feature, and thus a relatively smaller portion of users may encounter an existing bug over time. The opposite can also be true. For example, an application developer may want to simplify their application to reduce maintenance and development costs and thus may remove some ways of accessing certain features, or the developer may want to simplify the application so that it is more intuitive for users. This can mean that a bug that was previously encountered relatively infrequently is now encountered more frequently, as alternative paths of accessing a feature have been removed.

Accordingly, there is a need for systems and methods that can automatically determine thresholds or appropriate categorizations for various features. In some implementations, a machine learning model (e.g., the LLM used for triaging bugs or a different machine learning model) is used to automatically determine values for different factors for different features.

For example, as described herein, user flow priority can be based on the fraction of users in a relevant user base that use a feature associated with a bug. In some implementations, a machine learning model can access user interaction data (e.g., telemetry data) that indicates how users make use of an application. The machine learning model can be trained to assign a user flow priority based on the user interaction data. For example, the machine learning model can accept user interaction data as inputs and can output threshold values (e.g., threshold ratios) to be used for assigning user flow priorities to bugs. In some implementations, a system can be configured to automatically update priority factors (and resulting priorities) over time, for example by monitoring usage data and updating priority factors based on analysis of the usage data.

Often, multiple users submit reports for the same underlying bug. This can create significant challenges as there may be a large number of bug reports that relate to the same bug. Identifying similar/duplicate bugs can be a time-consuming process, and errors in identifying similar/duplicate bugs can result in wasted developer time, duplication of effort, and so forth. For example, if there are two different bug tasks that relate to the same bug, two different developers may invest time creating their own fixes for the bug, when only one fix is needed. In some implementations, a machine learning model is configured to compare bug tasks (e.g., using cosine similarity or another vector similarity metric) to identify potential duplicate bugs. In some implementations, bug tasks are automatically merged when the similarity between two bug tasks is above a threshold amount.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface-typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint.

Save Transactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

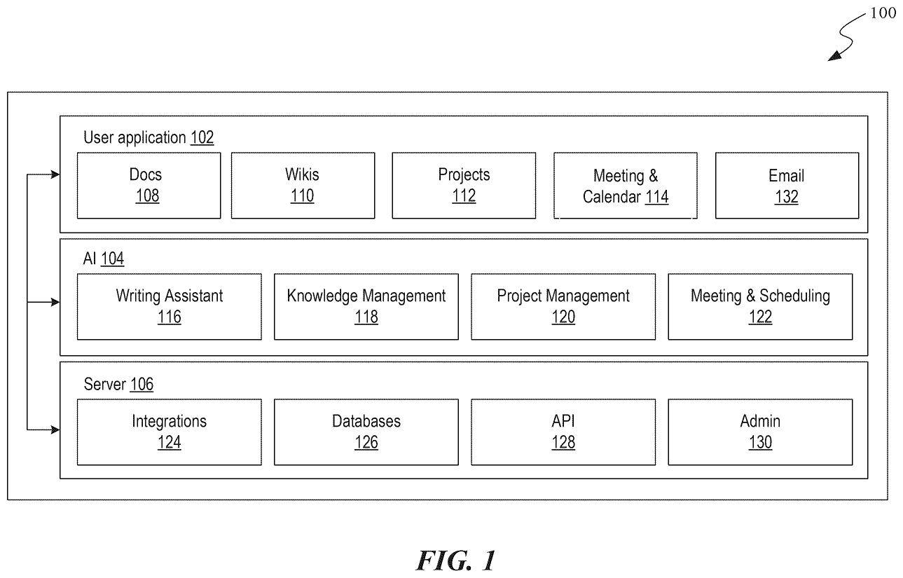

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100, can include an embedding of a document within the platform 100, or an embedding of a block within the document. In another example, a wiki can link to a meeting within the calendar.

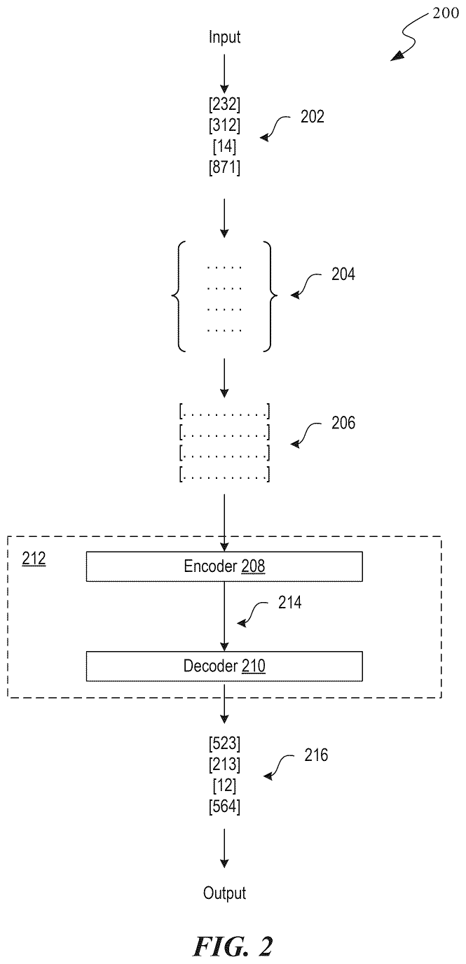

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). AI though transformer-based language models are described herein, it should be understood that the present disclosure may be applicable to any ML-based language model, including language models based on other neural network architectures such as RNN-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. AI though transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

AI though a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

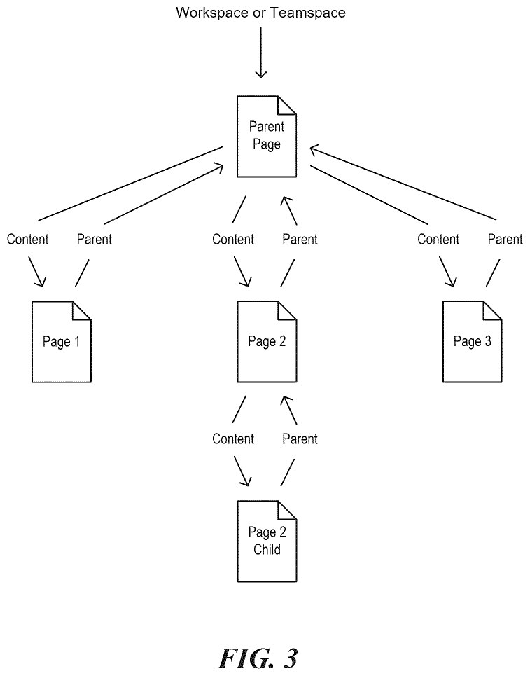

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. AI so, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Implementations

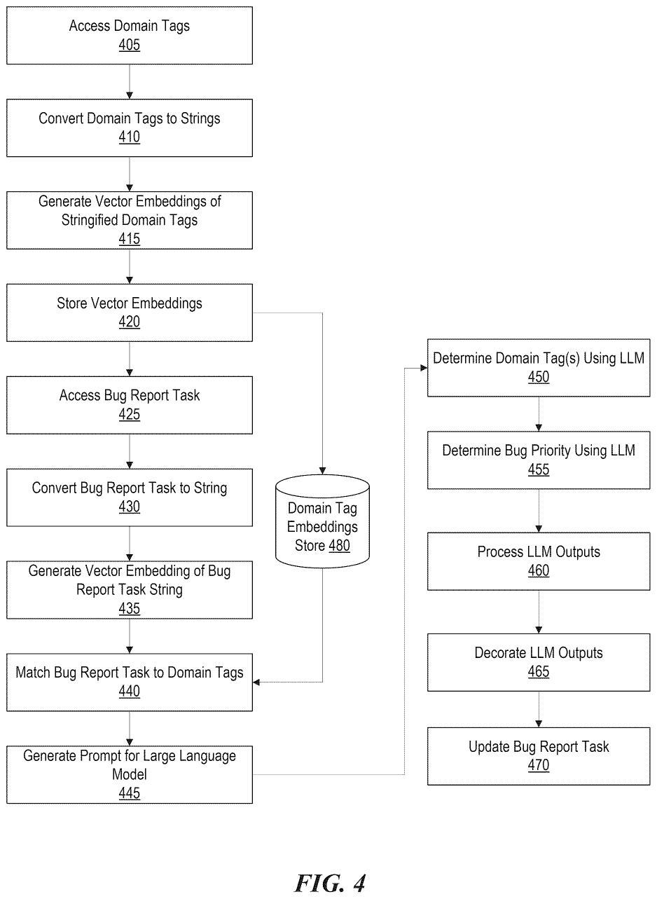

FIG. 4 is a flowchart that illustrates an example process for triaging a bug report according to some implementations. The process in FIG. 4 can be carried out using one or more computer systems (generally “system”) and can be carried out as a single process or as multiple processes. For example, in some implementations, some operations (e.g., operations 405-420) can be carried out separately from operations 425-470. At operation 405, a system can access domain tags. The domain tags can be stored in a database, for example in a database of a project management application. At operation 410, the system can convert the domain tags to strings. For example, as described herein, domain tags can include any of various information, such as a name, a plain text description of the product area, a priority associated with the product area, or any other relevant information. In some implementations, not all information associated with a domain tag is included whenever generating a string representation of the domain tag. For example, a domain tag could include information such as the name of the individual who created the domain tag, which may not be relevant to triaging bugs. At operation 415, the system can generate vector embeddings of the stringified domain tags. At operation 420, the system can store the vector embeddings of the stringified domain tags in a domain tag embeddings store 480. The domain tag embeddings store 480 can be a file, relational database, etc. In some implementations, the domain tag embeddings store can be an in-memory (e.g., volatile memory) data store, which can facilitate fast retrieval of information in the domain tag embeddings store 480.

At operation 425, the system can access a bug report task. The bug report task can be stored in, for example, a bug tracking database of a project management application. In some implementations, the system utilizes an API to access the bug report task. The bug report task can be a task that has not yet been triaged. At operation 430, the system can convert the bug report task to a string. For example, the system can select certain information (e.g., description, application name, etc.) and use such information to generate a string representation of the task. At operation 435, the system can generate a vector embedding of the bug report task string. At operation 440, the system can compare the bug report task string to domain tag embeddings in the domain tag embeddings store 480. The system can identify one or more domain tags to associate with the bug report task based on vector similarity of the vector embedding of the bug report task string to domain tag embeddings in the domain tag embeddings store 480. In some implementations, the system selects only the top domain tag. In some implementations, the system returns the top k domain tags, where k is an integer. In some implementations, the system returns all domain tags with a similarity above a threshold value.

At operation 445, the system can generate a prompt for a machine learning model (e.g., a large language model). The system can provide the prompt to the LLM which can determine domain tags at operation 450. At operation 455, the system can determine a bug priority for the bug report task using the LLM (or other machine learning model). At operation 460, the system can process the LLM outputs (or outputs from another machine learning model), for example to format the outputs in a particular way, to validate the outputs, to handle errors in the outputs, etc., the system can decorate the outputs with additional information. For example, the system can decorate the outputs with information related to a domain tag, such as the assigned product group, assigned customer support team, etc. At operation 470, the system can update the bug report task based on the decorations and the outputs of the LLM or other machine learning model.

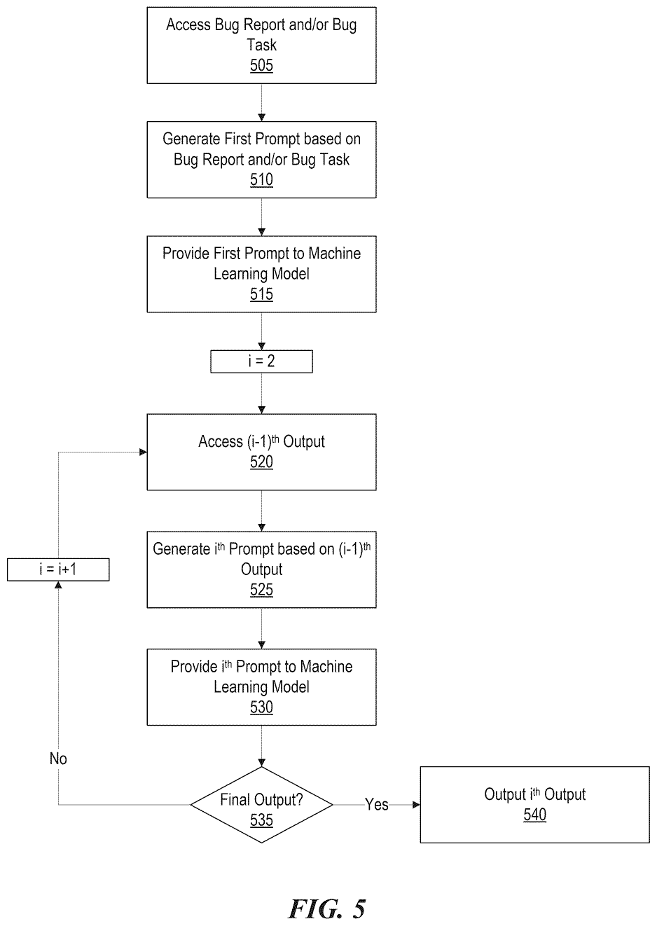

FIG. 5 is a flowchart that illustrates an example multi-step machine learning-based process for bug triage according to some implementations. At operation 505, a system can access a bug report, bug task, or both. As described herein, in some cases, bug tasks may be based on bug reports, or bug tasks and bug reports may be the same thing. At operation 510, the system can generate a first (i=1) prompt based at least in part on the bug report, bug task, or both. The first prompt can, in some implementations, include information such as a list of possible domain tags, for example as determined via vector similarity measures as described herein. At operation 515, the system can provide the first prompt to a machine learning model to cause the machine learning model to produce a first (i=1) output. The system can access the first output at operation 520 and, at operation 525, can generate a second prompt based at least in part on the first output. At operation 530, the system can provide the second prompt to the machine learning model to generate a second output. At operation 535, the system can determine if the second output is the final output. If not, the system can repeat operations 520, 525, and 530, using the second output to generate a third prompt and a third output. This process can continue iteratively until the final output is produced. At operation 540, the system can output the final (i^{th}) output. While described in terms of prompts, it will be appreciated that any suitable inputs can be used in conjunction with any suitable machine learning model, for example prompts used with an LLM.

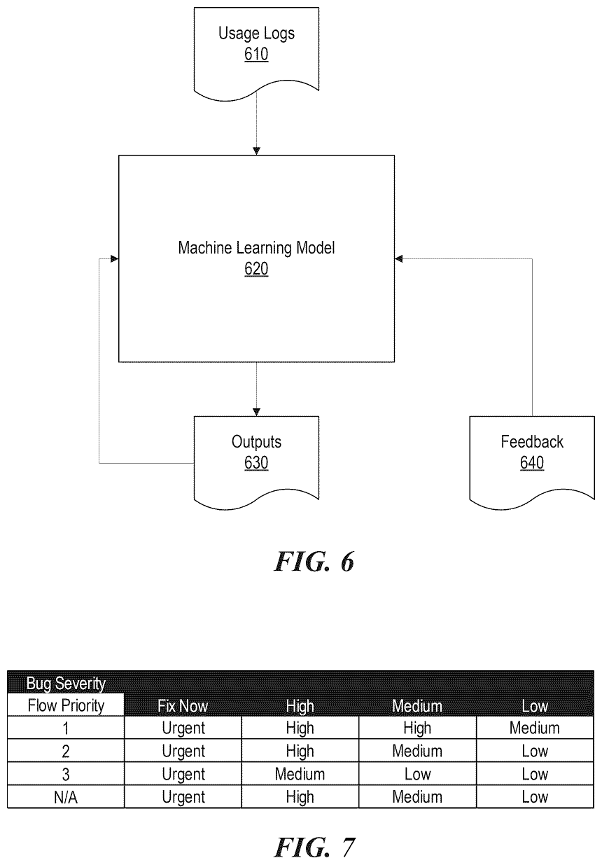

FIG. 6 is a block diagram that illustrates an example of machine learning model training and deployment according to some implementations. The machine learning model 620 can be configured to determine user flow priorities. The machine learning model 620 can ingest usage logs 610. The usage logs 610 can include information that can be used to determine the usage of different features or user flows within an application. The machine learning model 620 can analyze the usage logs 610 and produce outputs 630. The outputs 630 can be, for example, user flow priorities associated with features or user flows. The machine learning model can utilize the outputs 630 and feedback 640 to tune the machine learning model 620. For example, the feedback 640 can include information about, for example, users manually changing a user flow priority determined by the machine learning model 620. Tuning the machine learning model 620 can cause the machine learning model 620 to produce outputs 630 that more closely resemble the outputs that would be assigned by manual reviewers.

FIG. 7 is a table that shows an example of bug priorities determined based on priority factors of bug severity and user flow priority according to some implementations. It will be appreciated that this is merely an example, and other priority factors can be used additionally or alternatively.

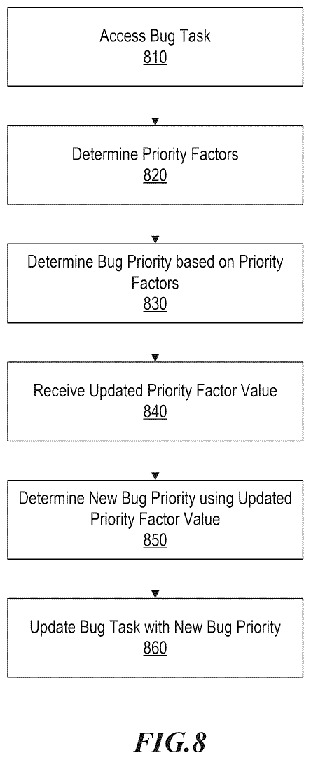

FIG. 8 is a flowchart that shows an example process for updating a bug severity according to some implementations. At operation 810, a system can access a bug task. At operation 820, the system can determine priority factors for the bug task, for example as described herein. At operation 830, the system can determine a bug priority for the bug task based on the priority factors, for example as described herein. A user can manually override or update one or more of the priority factors, for example using a desktop application, mobile application, or web application. At operation 840, the system can receive one or more updated priority factor values. At operation 850, the system can calculate a new bug priority using the one or more updated priority factor values (as well as zero or more priority factor values that were not updated). At operation 860, the system can update the bug task with the new bug priority. For example, the system can update a property of a block corresponding to the bug task in a task database.

### Computer System

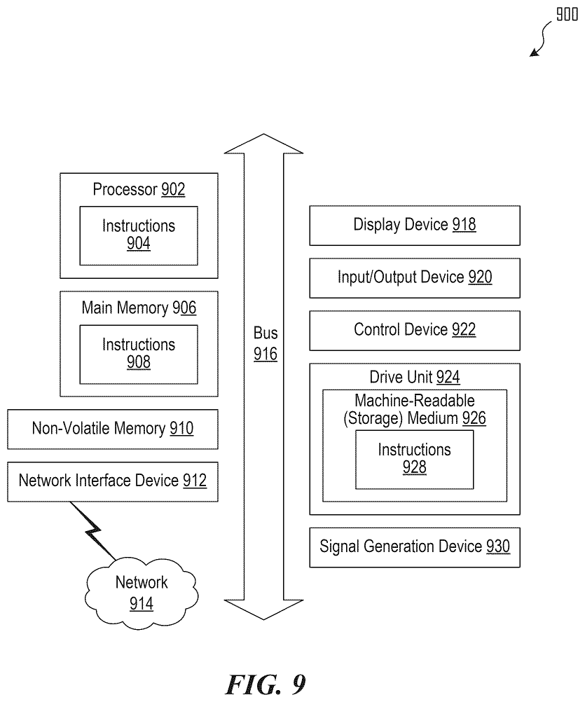

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, machine-readable medium 926) can be local, remote, or distributed. AI though shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

AI though implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. AI so, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A computer-implemented method for automatic bug triage, the computer-implemented method comprising:
accessing a bug report related to a bug in an application, wherein the bug report is a user-submitted bug report;
creating, in a task database based on the bug report, a bug task having a plurality of data items associated therewith;
accessing the bug task;
extracting one or more data items of the plurality of data items associated with the bug task,
wherein the one or more data items include at least one of: an application name, an application version, a web browser name, a web browser version, a user agent string, an operating system type, an operating system version, a debug report, a crash log, a display resolution, a display scaling factor, a crash report, a debug log, an error message, a screenshot, a timestamp, a title, a description, a region, a language, or a user-selected severity;
generating a first string representation of the one or more data items;
determining, based on the first string representation, a first vector representation in a vector space;
comparing the first vector representation to each second vector representation of a plurality of second vector representations in the vector space,
wherein each second vector representation of the plurality of second vector representations corresponds to a domain tag of a plurality of domain tags,
wherein each domain tag of the plurality of domain tags comprises a name and a description;
determining, based on the comparing, a plurality of associated second vector representations of the plurality of second vector representations;
generating at least one prompt for a large language model,
wherein the at least one prompt comprises at least one of: the plurality of associated second vector representations or a plurality of associated domain tags corresponding to the associated second vector representations of the plurality of second vector representations,
wherein the at least one prompt is configured to cause the large language model to output a determination of a matching domain tag selected from the plurality of associated domain tags corresponding to the associated second vector representations, and
wherein the at least one prompt is configured to cause the large language model to output a plurality of priority factor values comprising at least a first priority factor value and a second priority factor value,
wherein a final output generated by the large language model is a formatted output;
providing the at least one prompt to the large language model to cause the large language model to produce a final output;
determining, based on the final output of the large language model, a priority based on at least the first priority factor and the second priority factor;
determining, based on the final output of the large language model, a domain tag associated with the bug task; and
updating the bug task to include the domain tag associated with the bug task and the priority.

2. The computer-implemented method of claim 1, wherein the task database comprises data to populate one or more blocks of an integrated workspace, and
wherein each block comprises one or more properties.

3. The computer-implemented method of claim 1, wherein the at least one prompt comprises a first prompt and a second prompt, and wherein the second prompt is based at least in part on a first output produced by the large language model in response to the first prompt.

4. The computer-implemented method of claim 1, wherein the first priority factor is a user flow priority and the second priority factor is a bug severity,
wherein the user flow priority indicates a fraction of a user population impacted by the bug, and
wherein the bug severity indicates a level of impact of the bug on operation of an application associated with the bug.

5. A computer-implemented method for automatic bug triage, the computer-implemented method comprising:
accessing a bug task in a task database, wherein the bug task is based on a bug report, wherein the bug task has a plurality of data items associated therewith;
extracting one or more data items of the plurality of data items associated with the bug task;
generating a first string representation of the one or more data items;
determining, based on the first string representation, a first vector representation in a vector space;
comparing the first vector representation to each second vector representation of a plurality of second vector representations in the vector space,
wherein each second vector representation of the plurality of second vector representations corresponds to a domain tag of a plurality of domain tags,
determining, based on the comparing, a plurality of associated second vector representations of the plurality of second vector representations;
generating at least one input for a machine learning model,
wherein the at least one input comprises at least one of: the plurality of associated second vector representations or a plurality of associated domain tags corresponding to the associated second vector representations of the plurality of second vector representations, and
wherein the at least one input is configured to cause the machine learning model to output a determination of a matching domain tag selected from the plurality of associated domain tags corresponding to the associated second vector representations,
providing the at least one input to the machine learning model to cause the machine learning model to produce a final output indicating the matching domain tag; and
updating the bug task in the task database to include the matching domain tag.

6. The computer-implemented method of claim 5, wherein the plurality of second vector representations is stored in a volatile memory of a computer system.

7. The computer-implemented method of claim 5, wherein a total number of associated second vector representations is based on a number of second vector representations having a similarity with the first vector representation above a threshold amount.

8. The computer-implemented method of claim 5, wherein the at least one input comprises a first input and a second input, wherein the second input is based at least in part on a first input produced by the machine learning model in response to the first input.

9. The computer-implemented method of claim 5, wherein the one or more data items include at least one of: an application name, an application version, a web browser name, a web browser version, a user agent string, an operating system type, an operating system version, a debug report, a crash log, a display resolution, a display scaling factor, a crash report, a debug log, an error message, a screenshot, a timestamp, a title, a description, a region, a language, or a user-selected severity.

10. The computer-implemented method of claim 5, wherein each domain tag of the plurality of domain tags comprises a name and a description.

11. The computer-implemented method of claim 5, wherein the at least one input is configured to cause the machine learning model to output a plurality of priority factor values comprising at least a first priority factor value and a second priority factor value, the computer-implemented further comprising:
determining, based on the final output of the machine learning model, a priority based on at least the first priority factor and the second priority factor;
updating the bug task in the task database to include the priority.

12. The computer-implemented method of claim 11, wherein the first priority factor is a user flow priority and the second priority factor is a bug severity,
wherein the user flow priority indicates a fraction of a user population impacted by the bug, and
wherein the bug severity indicates a level of impact of the bug on operation of an application associated with the bug.

13. The computer-implemented method of claim 12, wherein the user population comprises a total number of users of the application.

14. The computer-implemented method of claim 5, wherein the machine learning model comprises a large language model, and wherein the at least one input comprises at least one prompt for the large language model.

15. A system for automatic bug triage, the system comprising:
at least one hardware processor; and
at least one non-transitory memory storing instructions which, when executed by the at least one hardware processor, cause the system to:
access a bug task in a task database, wherein the bug task is based on a bug report, wherein the bug task has a plurality of data items associated therewith;
extract one or more data items of the plurality of data items associated with the bug task;
generate a first string representation of the one or more data items;
determine, based on the first string representation, a first vector representation in a vector space;
compare the first vector representation to each second vector representation of a plurality of second vector representations in the vector space,
wherein each second vector representation of the plurality of second vector representations corresponds to a domain tag of a plurality of domain tags,
determine, based on the comparing, a plurality of associated second vector representations of the plurality of second vector representations;
generate at least one input for a machine learning model,
wherein the at least one input comprises at least one of: the plurality of associated second vector representations or a plurality of associated domain tags corresponding to the associated second vector representations of the plurality of second vector representations, and
wherein the at least one input is configured to cause the machine learning model to output a determination of a matching domain tag selected from the plurality of associated domain tags corresponding to the associated second vector representations,
provide the at least one input to the machine learning model to cause the machine learning model to produce a final output indicating the matching domain tag; and
update the bug task in the task database to include the matching domain tag.

16. The system of claim 15, wherein a total number of associated second vector representations is based on a number of second vector representations having a similarity with the first vector representation above a threshold amount.

17. The system of claim 15, wherein the at least one input comprises a first input and a second input, wherein the second input is based at least in part on a first input produced by the machine learning model in response to the first input.

18. The system of claim 15, wherein the one or more data items include at least one of: an application name, an application version, a web browser name, a web browser version, a user agent string, an operating system type, an operating system version, a debug report, a crash log, a display resolution, a display scaling factor, a crash report, a debug log, an error message, a screenshot, a timestamp, a title, a description, a region, a language, or a user-selected severity.

19. The system of claim 15, wherein the at least one input is configured to cause the machine learning model to output a plurality of priority factor values comprising at least a first priority factor value and a second priority factor value, wherein the instructions are further configured to cause the system to:
determine, based on the final output of the machine learning model, a priority based on at least the first priority factor and the second priority factor;
update the bug task in the task database to include the priority.

20. The system of claim 19, wherein the first priority factor is a user flow priority and the second priority factor is a bug severity,
wherein the user flow priority indicates a fraction of a user population impacted by the bug, and
wherein the bug severity indicates a level of impact of the bug on operation of an application associated with the bug.
